(19) United States
(12) Patent Application Publication
(10) Pub. No.: US 2021/0200280 A1
(43) Pub. Date: Jul. 1, 2021

(54) CONTROL METHOD, DATA PROCESSING DEVICE AND EXPANSION DEVICE

(71) Applicant: Lenovo (Beijing) Co., Ltd., Beijing (CN)

(72) Inventors: Xiaoju GAO, Beijing (CN); Rui YANG, Beijing (CN); Yueli HE, Beijing (CN); Haoqiang ZHOU, Beijing (CN)

(21) Appl. No.: 17/139,663

(22) Filed: Dec. 31, 2020

(30) Foreign Application Priority Data
Dec. 31, 2019 (CN) 201911423647.4
Dec. 31, 2019 (CN) 201911424293.5

(51) Int. Cl. G06F 1/16; H04R 1/10

(52) U.S. Cl. CPC G06F 1/1683; H04R 1/1025; G06F 1/1632; G06F 1/1698

(57) ABSTRACT

A control method includes making, by a first interaction component, a wireless connection according to a connection rule in response to the first interaction component switching from a first state to a second state; and making, by a second interaction component, the wireless connection according to the connection rule in response to the second interaction component switching from the first state to the second state.

### CROSS-REFERENCE TO RELATED APPLICATION

This application claims priorities to Chinese Patent Application No. 201911423647.4 filed on Dec. 31, 2019 and Chinese Patent Application No. 201911424293.5 filed on Dec. 31, 2019, the entire contents of which are incorporated herein by reference.

### TECHNICAL FIELD

The present disclosure relates to the technical field of controls and, more particularly, to a control method, an expansion device, and a processing device.

### BACKGROUND

In related technologies, when being used to connect to a processing device for answering a phone call, video conferencing, or audio playback, a Bluetooth headset has a number of issues. The Bluetooth headset requires a master/slave pairing before it can be used. Because earphones of the Bluetooth headset look similarly, it is hard for a user to tell the difference between a master earphone and a slave earphone. When the user rushes to answer an incoming phone call for his/her cell phone, it is likely for the user to mix up the master earphone and the slave earphone. When the user pulls out and turns on one earphone, the user may turn on the slave earphone. However, the slave earphone is unable to directly establish a connection with the processing device or in this case, the cell phone. Because the user is often anxious to answer the incoming phone call, the user may not have time to pull out the master earphone, thereby degrading user's experience of the Bluetooth headset. Similar issues also exist with personal computers.

Therefore, it is important to have better control of making connections with Bluetooth devices.

### SUMMARY

The present disclosure provides a control method. The method includes making, by a first interaction component, a wireless connection according to a connection rule in response to the first interaction component switching from a first state to a second state; and making, by a second interaction component, the wireless connection according to the connection rule in response to the second interaction component switching from the first state to the second state.

The present disclosure also provides an expansion device. The device includes a first body adapted to a first accommodation space of a processing device for accommodating the expansion device, and including a second accommodation space; a first interaction component configured to be accommodated in the second accommodation space and input and/or output data; a first communication component configured to make a first connection with the processing device; a second communication component configured to make a second connection with the first interaction component; and a third communication component configured to make a third connection with the first interaction component, wherein the first interaction component connects with the processing device through the second connection or the third connection.

The present disclosure also provides a processing device. The device includes a second body including a first accommodation space; a fifth communication component configured to make a first connection with an expansion device; and the expansion device including: a first body adapted to the first accommodation space and including a second accommodation space, such that the expansion device is accommodated in the first accommodation space; a first communication component configured to make the first connection with the fifth communication component; a second communication component configured to make a second connection with a first interaction component; a third communication component configured to make a third connection with the first interaction component; and the first interaction component capable of being accommodated in the second accommodation space and including a sixth communication component configured to make the second connection with the second communication component, wherein the first interaction component is connected through the second connection or the third connection.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart illustrating an exemplary control method according to some embodiments of the present disclosure;

FIG. 2 is a schematic diagram illustrating connections between an exemplary expansion device, a processing device, and interaction components according to some embodiments of the present disclosure;

FIG. 3 is a flowchart illustrating another exemplary control method according to some embodiments of the present disclosure;

FIG. 4 is a structural diagram illustrating an exemplary control apparatus according to some embodiments of the present disclosure;

FIG. 5 is a structural diagram illustrating another exemplary control apparatus according to some embodiments of the present disclosure;

FIG. 6 is a structural diagram of an exemplary expansion device according to some embodiments of the present disclosure;

FIG. 7 is a structural diagram of another exemplary expansion device according to some embodiments of the present disclosure;

FIG. 8 is a structural diagram of an exemplary processing device according to some embodiments of the present disclosure;

FIG. 9 is a flowchart illustrating an exemplary data transmission method according to some embodiments of the present disclosure;

FIG. 10 is a schematic diagram of an application example of a processing device and a first interaction component according to some embodiments of the present disclosure;

FIG. 11 is a schematic diagram of an application example of an expansion device and a first interaction component according to some embodiments of the present disclosure; and

FIG. 12 is a schematic diagram of another application example of an expansion device and a first interaction component according to some embodiments of the present disclosure.

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure. In addition, under circumstances of no conflict, the embodiments and the features in the embodiments may be combined with each other.

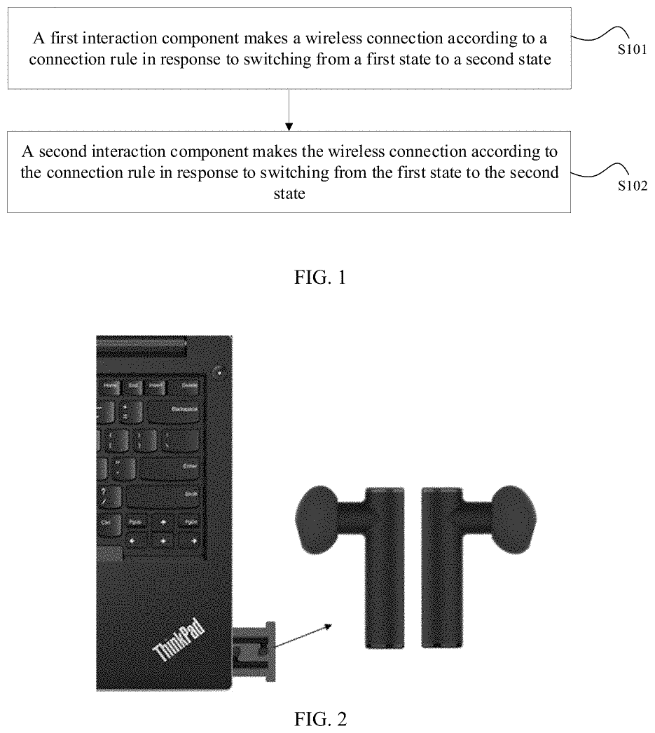

The present disclosure provides a control method for Bluetooth devices. FIG. 1 is a schematic flowchart illustrating an exemplary control method according to some embodiments of the present disclosure. As shown in FIG. 1, the control method includes the following processes.

At S101, a first interaction component makes a wireless connection according to a connection rule in response to switching from a first state to a second state.

At S102, a second interaction component makes the wireless connection according to the connection rule in response to switching from the first state to the second state.

In some embodiments, the first interaction component is a left-channel earphone of a wireless headset, and the second interaction component is a right-channel earphone of the wireless headset. In some other embodiments, the first interaction component is the right-channel earphone of the wireless headset, and the second interaction component is the left-channel earphone of the wireless headset. In other words, the first interaction component and the second interaction component are two components interacting with each other and appearing in pairs. In some embodiments, the first interaction component and the second interaction component may be components of another type of electronic device. For example, the first interaction component and the second interaction component may be left and right eye pieces of a wireless virtual reality glasses for receiving audio and video data of a target device.

In this specification, the interaction component refers to either the first interaction component or the second interaction component, and the earphone refers to either the left-channel earphone or the right-channel earphone.

In some embodiments, the first state refers to a state that the interaction component is in contact with a target contact surface. The second state refers to a state that the interaction component is separated from the target contact surface.

In some embodiments, the first interaction component and the second interaction component are two wireless earphones placed inside a target device. In some embodiments, the target device may be a tray that accommodates the two wireless earphones. The tray includes an accommodation space for accommodating the two wireless earphones. The tray has a wireless communication function, and may make a wireless connection such as a Bluetooth connection or a Wi-Fi connection with the wireless earphones. The wireless earphones exchange data with an electronic device through the tray. The tray may be disposed at the electronic device.

In some embodiments, the target device may be an electronic device such as a notebook computer, a cell phone, a desktop computer, a tablet computer, a game console, and a personal digital assistant. The two wireless earphones may be placed in the accommodation space of the target device.

In some embodiments, whether the interaction component is pulled out by the user is determined by detecting whether the interaction component is separated from the target contact surface. After it is detected that the interaction component is separated from the target contact surface, it is determined that the interaction component is pulled out by the user. As such, the interaction component that is pulled out first from the accommodation space becomes the master interaction component to make the connection with the target device, and the master interaction component that is pulled out first exchanges the data with the target device. When only one interaction component is pulled out from the target device, the pulled-out interaction component is able to communicate with the target device and to exchange the related data. The first pulled-out interaction component turns on automatically and activates its wireless connection function to make the wireless connection with the target device. In this case, the target contact surface refers to a support surface in the accommodation space of the interaction component, that is, the support surface that supports the interaction component accommodated in the accommodation space.

In some embodiments, the connection rule is that the interaction component that is first separated from the target contact surface is the master interaction component for connecting with the target device.

In some embodiments, the first state refers to that the interaction component and the target device are communicatively connected, and the second state refers to that the interaction component and the target device are communicatively disconnected.

In some embodiments, the connection or the disconnection between the interaction component and the target device is a condition for triggering the connection rule to turn on the interaction component. That is, when the first interaction component and the second interaction component are placed in the accommodation space of the target device, the first interaction component and the second interaction component are communicatively connected to the target device. After at least one of the first interaction component or the second interaction component is pulled out by the user from the accommodation space of the target device, the pulled-out interaction component is communicatively disconnected from the target device. Thus, whether the interaction component is pulled out can be determined by detecting a state of the communication connection between the interaction component and the target device. After the interaction component is communicatively disconnected from the target device, that is, the interaction component is pulled out by the user, the interaction component that is pulled out first is selected as the master interaction component to make the connection with the target device. As such, the pulled-out master interaction component exchanges the data with the other interaction component. In the case that the user is anxious to use only one interaction component that is pulled out, the pulled-out interaction component makes the communication connection with the target device to exchange the related data. The first pulled-out interaction component automatically turns on, launches the wireless connection function, and makes the wireless connection with the target device.

In some embodiments, the connection rule includes the following processes. The interaction component attempts to connect with another interaction component. In the case the attempt fails, the interaction component attempts to connect with the target device.

In some other embodiments, the connection rule includes the following processes. The interaction component attempts to connect with another interaction component. In the case the connection attempt succeeds, the interaction component becomes a slave interaction component. In the case the connection attempt fails, it indicates an absence of a master interaction component connected with the target device. The interaction component assumes the role of the master interaction component and attempts to connect with the target device. In the connection rule, there is no need to identify the master interaction component from the first interaction component and the second interaction component. Instead, the master interaction component is automatically determined according to an order that the user pulls out the interaction component.

In some embodiments, the connection rule further includes the following processes. The interaction component attempts to connect with another interaction component. In the case the attempt to connect with another interaction component fails, the interaction component attempts to connect with the target device. In the case the attempt to connect with the target device fails, the interaction component attempts to connect with a device with a device identifier that appears in the history of connected devices. In the case the attempt to connect with the device in the history of connected devices fails, the interaction component enters a pairing connection state.

In the above-described connection rule, the first two steps are the same as in the previously described connection rules. Initially, another interaction component is searched to determine whether any interaction component has already connected with the target device. After it is determined that no interaction component has already connected with the target device, the interaction component attempts to connect with the target device. In the case the attempt to connect with the target device fails, the interaction component randomly or sequentially selects one target device from a locally stored list of previously connected target devices and attempts to connect with the selected target device. In the case the locally stored list of the previously connected target devices is empty or the attempt to connect with the selected target device fails, the interaction component enters the pairing connection state, waits for another wireless device such as a Bluetooth device to initiate a pairing request, and attempts to connect with the wireless device requested for pairing.

In some embodiments, after remaining in the pairing connection state for a first pre-configured time, the interaction component automatically turns off. In some other embodiments, after remaining in the pairing connection state for the first pre-configured time, the interaction component makes another connection attempt according to the connection rule. In the case that the repeated connection attempt fails, the interaction component enters the pairing connection state again. After remaining in the pairing connection state for a second pre-configured time, the interaction component automatically turns off.

In some embodiments, when the second interaction component remains in the first state and the first interaction component switches from the first state to the second state, the first interaction component makes a first connection with the target device according to the connection rule. When the first interaction component remains in the first state and the second interaction component switches from the first state to the second state, the second interaction component makes the first connection with the target device according to the connection rule.

In some embodiments, after one of the first interaction component and the second interaction component is pulled out from the accommodation space of the target device, at least one of the first interaction component or the second interaction component is communicatively connected with or disconnected from the target device. Thus, the pulled-out interaction component launches the wireless connection function and makes the wireless connection according to the connection rule.

For illustration purpose, the interaction components are the Bluetooth headset including the left-channel earphone and the right-channel earphone. Neither the left-channel earphone nor the right-channel earphone is configured as a master earphone. In some embodiments, after the left-channel earphone is pulled out by the user from the accommodation space of the target device, the right-channel earphone remains in the accommodation space of the target device. As such, the left-channel earphone turns on, launches the Bluetooth function, and makes the wireless connection according to a pre-configured connection rule. Because only one earphone is pulled out, as a result of the left-channel earphone making the wireless connection according to the connection rule, the left-channel earphone assumes the role as the master earphone and makes the wireless connection with the target device while the right-channel earphone remains in a turn-off state.

In some other embodiments, after the right-channel earphone is pulled out by the user from the accommodation space of the target device, the left-channel earphone remains in the accommodation space of the target device. As such, the right-channel earphone turns on, launches the Bluetooth function, and makes the wireless connection according to the pre-configured connection rule. Because only one earphone is pulled out, as a result of the right-channel earphone making the wireless connection according to the connection rule, the right-channel earphone assumes the role as the master earphone and makes the wireless connection with the target device while the left-channel earphone remains in the turn-off state.

In some embodiments, after the first interaction component and the second interaction component both switch from the first state to the second state, the first interaction component and the second interaction component are connected with the target device in different manners. When the first interaction component makes the first connection directly with the target device, the second interaction component makes the first connection with the target device indirectly through the first interaction component. When the second interaction component makes the first connection directly with the target device, the first interaction component makes the first connection with the target device indirectly through the second interaction component.

In this application scenario, the first interaction component and the second interaction component both are pulled out from the accommodation space of the target device. The first interaction component and the second interaction component both launch the wireless connection function and make the wireless connection according to the connection rule. The interaction component that first connects with the target device becomes the master interaction component and the other interaction component becomes the slave interaction component and make the wireless connection with the master interaction component. As such, the slave interaction component connects with the target device through the master interaction component. The master interaction component connects with the target device directly while the slave interaction component connects with the target device indirectly through the master interaction component. The master interaction component and the slave interaction component are connected with the target device in different manners. In some embodiments, the first connection is the wireless connection. The master interaction component makes the wireless connection with the target device directly while the slave interaction component makes the wireless connection with the target device indirectly through the master interaction component.

For illustration purpose, the interaction components are the Bluetooth headset including the left-channel earphone and the right-channel earphone. Neither the left-channel earphone nor the right-channel earphone is configured as the master earphone. In some embodiments, after the left-channel earphone and the right-channel earphone both are pulled out by the user from the accommodation space of the target device, the left-channel earphone and the right-channel earphone both turn on, launch the Bluetooth function, and make the wireless connection according to the pre-configured connection rule. The earphone that first connects with the target device becomes the master earphone while the earphone that has not connected with the target device becomes the slave earphone. The slave earphone makes the wireless connection with the master earphone according to the connection rule and connects with the target device through the master earphone.

In some embodiments, because neither the left-channel earphone nor the right-channel earphone is configured as the master earphone, after the left-channel earphone and the right-channel earphone are pulled out from the accommodation space of the target device, both earphones attempt to connect with each other according to the connection rule. After the attempt to connect with another earphone fails, both earphones attempt to connect with the target device. After one earphone successfully connects with the target device, the other earphone becomes the slave earphone. The slave earphone connects with the target device indirectly through the master earphone.

In the embodiments of the present disclosure, the connection rule includes the following processes. Initially, the interaction component attempts to connect with another interaction component. After the attempt to connect with another interaction component fails, the interaction component attempts to connect with the target device. After the attempt to connect with the target device fails, the interaction component attempts to connect with a previously connected device. After the attempt to connect with any previously connected device fails, the interaction component enters the pairing connection state without affecting another interaction component to attempt to connect as the slave interaction component. After the slave interaction component searches for but fails to connect with the master interaction component, the slave interaction component searches for and attempts to connect with the target device. After the attempt to connect with the target device fails, the salve interaction component searches for and attempts to connect with a previously connected device. In this way, it is still possible for the slave interaction component to find and connect with the target device. In the case that the target device has never been connected by the interaction component, the slave interaction component enters the pairing connection state. After waiting for the first pre-configured time, the slave interaction component attempts to connect again according to the connection rule. Eventually, the slave interaction component connects with the target device indirectly through the master interaction component.

In some embodiments, when switching from a third state to a fourth state, the first interaction component and the second interaction component activate a wireless circuit thereof, respectively. The first interaction component includes a first wireless circuit and the second interaction component includes a second wireless circuit. The third state refers to that a second connection between an expansion device and a processing device is connected. The fourth state refers to that the second connection between the expansion device and the processing device is disconnected. The interaction component is disposed inside the expansion device and is in the first state. The second state is different from the first state.

In some embodiments, the third state refers to that after the first interaction component and the second interaction component are accommodated in an accommodation space of the expansion device, the expansion device is accommodated in an accommodation space of the processing device. In this way, the expansion device and the processing device are connected through contact, such as through an interface or a metal contact. After the expansion device is pulled out from the accommodation space of the processing device, the first interaction component and the second interaction component are pulled out together with the expansion device from the accommodation space of the processing device. In this case, the expansion device and the processing device are disconnected, which is the fourth state. In the fourth state, the expansion device and the processing device are disconnected from each other. The third state refers to that the expansion device is pushed in to the accommodation space of the processing device. In the third state, the expansion device makes the second connection through the interface or the metal contact. The third state and the fourth state consistent with the embodiments of the present disclosure are described in detail below with reference to the accompanying drawings.

FIG. 2 is a schematic diagram illustrating connections between an exemplary expansion device, a processing device, and interaction components according to some embodiments of the present disclosure. As shown in FIG. 2, the interaction components are the Bluetooth headset including the left-channel earphone and the right-channel earphone. The processing device is equivalent to a main unit of a laptop computer. The expansion device is equivalent to a tray for accommodating the Bluetooth headset. The tray can be inserted into the main unit of the laptop computer, and can be ejected or turned off from the laptop computer. After the tray is inserted into the main unit of the laptop computer, the tray is connected with the laptop computer through the metal contact or the interface connection. After the tray is ejected from the main unit of the laptop computer, the tray is disconnected from the laptop computer.

The tray has Bluetooth connection function, that is, the wireless connection function. After the earphone is turned on, the earphone is wirelessly connected with the tray and is connected with the laptop computer indirectly through the tray. As such, from the earphone, the user can hear audio data outputted from the laptop computer.

In some embodiments, the above-described target device may be the laptop computer shown in FIG. 2, the tray (i.e., the expansion device) shown in FIG. 2, or both the laptop computer and the tray. The fourth state refers to that the tray is ejected from the laptop computer. At this time, the Bluetooth headset is still placed in the accommodation space of the tray. The third state refers to that the tray is inserted into the laptop computer.

In some embodiments, after the earphone determines that the tray is ejected from the laptop computer, the earphone only activates its own Bluetooth function. The earphone does not make the wireless connection with either the tray or the laptop computer. Only after the earphone is pulled out by the user from the tray, the earphone detects the pull-out and launches Bluetooth connection function. The pulled-out earphone makes the wireless connection with either the tray or the master earphone to receive the audio data outputted from the laptop computer through the connection with the tray.

In the control method provided by the embodiments of the present disclosure, after the first interaction component switches from the first state to the second state, the first interaction component makes the wireless connection according to the connection rule. After the second interaction component switches from the first state to the second state, the second interaction component makes the wireless connection according to the connection rule. The first state refers to that the interaction component contacts with the target contact surface. The second state refers to that the interaction component separates from the target contact surface. The first state may also refer to that the interaction component is communicatively connected with the target device. The second state may also refer to that the interaction component is communicatively disconnected from the target device. As long as the interaction component separates from the target contact surface or is communicatively disconnected from the target device, the interaction component searches for the master interaction component. In the case that the master interaction component is found, the interaction component connects with the master interaction component. In the case that the master interaction component is not found, the interaction component searches for the target device to connect with the target device. The interaction component needs not be pre-configured as either master interaction component or the slave interaction component. The interaction component that is used first by the user becomes the master interaction component, which connects with the target device. Thus, it is not necessary to identify the master interaction component or the slave interaction component, thereby removing the constraint on the user behavior and substantially improving the user experience.

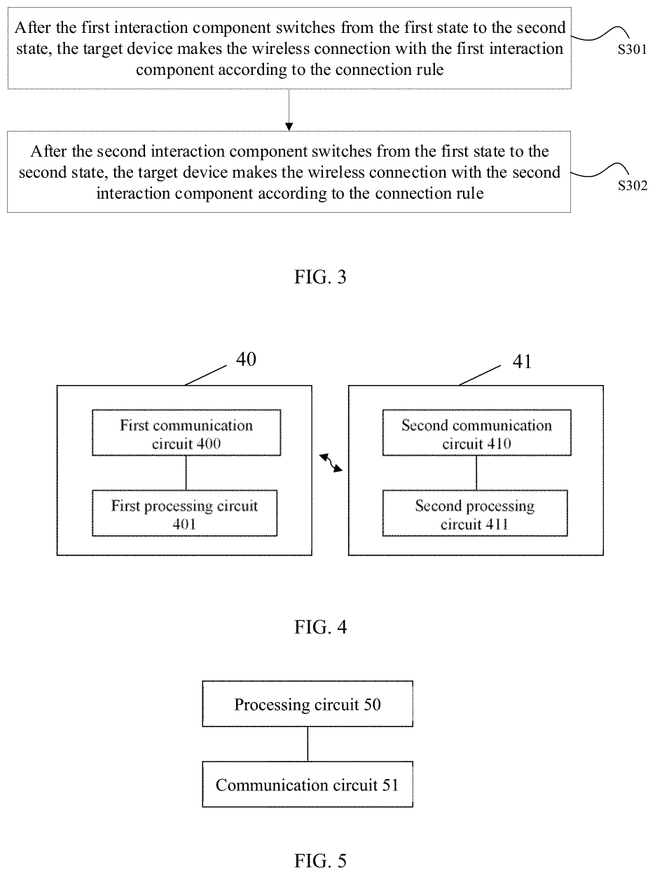

FIG. 3 is a schematic flowchart illustrating another exemplary control method according to some embodiments of the present disclosure. As shown in FIG. 3, the control method includes the following processes.

At S301, after the first interaction component switches from the first state to the second state, the target device makes the wireless connection with the first interaction component according to the connection rule.

At S302, after the second interaction component switches from the first state to the second state, the target device makes the wireless connection with the second interaction component according to the connection rule.

In some embodiments, the first interaction component is the left-channel earphone of the wireless headset and the second interaction component is the right-channel earphone of the wireless headset. In some other embodiments, the first interaction component is the right-channel earphone of the wireless headset and the second interaction component is the left-channel earphone of the wireless headset. In other words, the first interaction component and the second interaction component are two components interacting with each other and appearing in pairs. In some embodiments, the first interaction component and the second interaction component may be components of another type of electronic device. For example, the first interaction component and the second interaction component may be left and right eye pieces of a wireless virtual reality glasses for receiving audio and video data of the target device.

The first state refers to a state that the interaction component is in contact with a target contact surface. The second state refers to a state that the interaction component is separated from the target contact surface.

In some embodiments, the first interaction component and the second interaction component are two wireless earphones disposed inside the target device. In some embodiments, the target device is a tray capable of accommodating the two wireless earphones. The tray includes an accommodation space for accommodating the two wireless earphones. The tray has a wireless connection function for making a wireless connection, such as Bluetooth connection or Wi-Fi connection, with the two wireless earphones. The tray may be a structure shown in FIG. 2. The wireless earphones exchange data with an electronic device through the tray. The tray is disposed inside the electronic device.

In some embodiments, the target device may be an electronic device such as a notebook computer, a cell phone, a desktop computer, a tablet computer, a game console, and a personal digital assistant. The two wireless earphones may be placed in the accommodation space of the target device.

In some embodiments, whether the interaction component is pulled out by the user is determined by detecting whether the interaction component is separated from the target contact surface. After it is detected that the interaction component is separated from the target contact surface, it is determined that the interaction component is pulled out by the user. As such, the target device makes the connection with the interaction component that is pulled out first from the accommodation space, and the interaction component that is pulled out first becomes the master interaction component. The target device exchanges the data with the master interaction component that is pulled out first. When only one interaction component is pulled out from the target device, the pulled-out interaction component is able to communicate with the target device and to exchange the related data. In this case, the target contact surface refers to a support surface in the accommodation space of the interaction component, that is, the support surface that supports the interaction component accommodated in the accommodation space.

In some embodiments, the connection rule is that the interaction component that is first separated from the target contact surface is the master interaction component for connecting with the target device.

In one example, the first state refers to that the interaction component and the target device are communicatively connected, and the second state refers to that the interaction component and the target device are communicatively disconnected.

In some embodiments, the connection or the disconnection between the interaction component and the target device is a condition for triggering the connection rule to turn on the interaction component. That is, when the first interaction component and the second interaction component are placed in the accommodation space of the target device, the first interaction component and the second interaction component are communicatively connected to the target device. After at least one of the first interaction component or the second interaction component is pulled out by the user from the accommodation space of the target device, the pulled-out interaction component is communicatively disconnected from the target device. The target determines whether the interaction component is pulled out by detecting a state of the communication connection between the interaction component and the target device. After the interaction component is communicatively disconnected from the target device, that is, the interaction component is pulled out by the user, the target device makes the connection with the interaction component that is pulled out first from the accommodation space and the interaction component that is pulled out first then exchanges the data with the target device. When the user only pulls out one interaction component from the target device, the pulled-out interaction component is still able to be communicatively connected with the target device and to exchange the data with the target device. The first pulled-out interaction component automatically turns on, launches the wireless connection function, and makes the wireless connection with the target device.

In some embodiments, the connection rule includes that the target device attempts to connect with the interaction component that is pulled out first. In the case the attempt to connect with the interaction component that is pulled out first fails, the target device attempts to connect with another interaction component that is pulled out.

In some other embodiments, the target device attempts to connect with two interaction components that are pulled out. In the case the attempt to connect with one of them succeeds, the target device terminates the attempt to connect with the other interaction component. That is, after both interaction components are pulled out from the target device, the target device attempts to connect with both interaction components. After it is determined that the attempt to connect with one of them succeeds, the target device terminates the attempt to connect with the other interaction component.

In the control method provided by the embodiments of the present disclosure, after the target device determines that the interaction component is disconnected from the target device or is pulled out from the target device, the target device attempts to connect with the interaction component that is pulled out first or connects with the interaction component that is connected with the target device first while terminating the attempt to connect with the other interaction component. The target device automatically determines the master interaction component and the slave interaction component and makes the connection accordingly. Thus, it ensures that the user does not need to identify the master interaction component and the slave interaction component, thereby making it convenient for the user to operate the interaction components and improving the user experience.

FIG. 4 is a structural diagram illustrating an exemplary control apparatus according to some embodiments of the present disclosure. As shown in FIG. 4, the control apparatus includes a first interaction component 40 and a second interaction component 41. The first interaction component 40 includes a first communication circuit 400 and a first processing circuit 401. The first communication circuit 400 is configured to determine whether the first interaction component 40 switches from a first state to a second state and activates the first processing circuit 401 in response to the first interaction component 40 switching from the first state to the second state. The first processing circuit 401 is configured to make a wireless connection according to a connection rule. The second interaction component 41 includes a second communication circuit 410 and a second processing circuit 411. The second communication circuit 410 is configured to determine whether the second interaction component 41 switches from the first state to the second state and activates the second processing circuit 411 in response to the second interaction component 41 switching from the first state to the second state. The second processing circuit 411 is configured to make the wireless connection according to the connection rule.

In this specification, the interaction component refers to either the first interaction component 40 or the second interaction component 41.

In some embodiments, the first state refers to a state that the interaction component is in contact with a target contact surface. The second state refers to a state that the interaction component is separated from the target contact surface. In some other embodiments, the first state refers to that the interaction component and a target device are communicatively connected, and the second state refers to that the interaction component and the target device are communicatively disconnected.

In some embodiments, the connection rule includes the following processes. The interaction component attempts to connect with another interaction component. In the case the attempt fails, the interaction component attempts to connect with the target device.

In some other embodiments, the connection rule includes the following processes. The interaction component attempts to connect with another interaction component. In the case the connection attempt fails, the interaction component attempts to connect with the target device. In the case the connection attempt fails, the interaction component attempts to connect with a previously connected device. In the case the connection attempt fails, the interaction component enters a pairing connection state.

In some embodiments, when the second interaction component 41 remains in the first state and the first interaction component 40 switches from the first state to the second state, the first interaction component 40 makes a first connection with the target device according to the connection rule through the first communication circuit 400. When the first interaction component 40 remains in the first state and the second interaction component 41 switches from the first state to the second state, the second interaction component 41 makes the first connection with the target device according to the connection rule through the second communication circuit 410.

In some embodiments, after the first interaction component 40 and the second interaction component 41 both switch from the first state to the second state, the first interaction component 40 and the second interaction component 41 are connected with the target device in different manners.

In some embodiments, when the first interaction component 40 makes the first connection directly with the target device, the second interaction component 41 makes the first connection with the target device indirectly through the first interaction component 40. When the second interaction component 41 makes the first connection directly with the target device, the first interaction component 40 makes the first connection with the target device indirectly through the second interaction component 41.

In some embodiments, when the first interaction component 40 and the second interaction component 41 switch from a third state to a fourth state, the first interaction component 40 and the second interaction component 41 activate the first communication circuit 400 and the second communication circuit 410, respectively. The third state refers to that a second connection between an expansion device and a processing device is connected. The fourth state refers to that the second connection between the expansion device and the processing device is disconnected. The interaction component is disposed inside the expansion device and is in the first state. The second state is different from the first state.

Those skilled in the art should understand that the control apparatus shown in FIG. 4 is the electronic device to implement the control method shown in FIG. 1. The functions of various circuits and the operation principles may be referred to the description of the control method shown in FIG. 1.

FIG. 5 is a structural diagram illustrating another exemplary control apparatus according to some embodiments of the present disclosure. As shown in FIG. 5, the control apparatus includes a processing circuit 50 and a communication circuit 51. The processing circuit 50 is configured to determine whether the first interaction component switches from the first state to the second state, and activates the communication circuit 51 in response to the first interaction component switching from the first state to the second state. The communication circuit 51 is configured to make the wireless connection with the first interaction component according to the connection rule. The processing circuit 50 is further configured to determine whether the second interaction component switches from the first state to the second state and activates the communication circuit 51 to make the wireless connection with the second interaction component according to the connection rule in response to the second interaction component switching from the first state to the second state.

In some embodiments, the connection rule includes that the target device attempts to connect with the interaction component that is pulled out first. In the case the attempt to connect with the interaction component that is pulled out first fails, the target device attempts to connect with another interaction component that is pulled out.

In some other embodiments, the target device attempts to connect with two interaction components that are pulled out. In the case the attempt to connect with one of them succeeds, the target device terminates the attempt to connect with the other interaction component. That is, after both interaction components are pulled out from the target device, the target device attempts to connect with both interaction components. After it is determined that the attempt to connect with one of them succeeds, the target device terminates the attempt to connect with the other interaction component.

Those skilled in the art should understand that the control apparatus shown in FIG. 5 is the electronic device to implement the control method shown in FIG. 3. The functions of various circuits and the operation principles may be referred to the descriptions of the control method shown in FIG. 1 and FIG. 3.

The technical solutions of the embodiments of the present disclosure are described in detail below with practical examples.

In some embodiments, as shown in FIG. 3, true wireless stereo (TWS) earphones are directly integrated into a laptop computer. After a user pulls out an earphone from a tray. The earphone automatically turns on. After the user places the earphone back into the tray, the earphone automatically turns off. After the earphone is pulled out from the tray, the earphone automatically turns on and searches for a pairing earphone. In the case the pairing earphone is found, it indicates that the pairing earphone has already been connected with the target device. The pairing earphone connected with the target device automatically becomes the master earphone. The currently pulled-out earphone becomes the slave earphone, searches for the master earphone, attempts to connect with the master earphone, and eventually connects with the target device through the master earphone. In the case the pairing earphone is not found, the earphone searches for the target device and attempts to connect with the target device. In the case the attempt to connect with the target device fails, the earphone searches for a candidate device in a locally stored list of previously paired/connected devices and attempts to connect with the candidate device. In the case the attempt to connect with the candidate device fails, the earphone enters the pairing connection state and waits for another device attempting to pair/connect. In the case the pairing attempt from another device does not occur or fails for the first pre-configured time, the earphone turns off.

In some other embodiments, after the pairing attempt from another device does not occur or fails for the first pre-configured time, the earphone repeats the search for the master earphone, the target device, the candidate device, and the pairing attempt from another device. After the repeated search fails, the earphone turns off after waiting for the second pre-configured time.

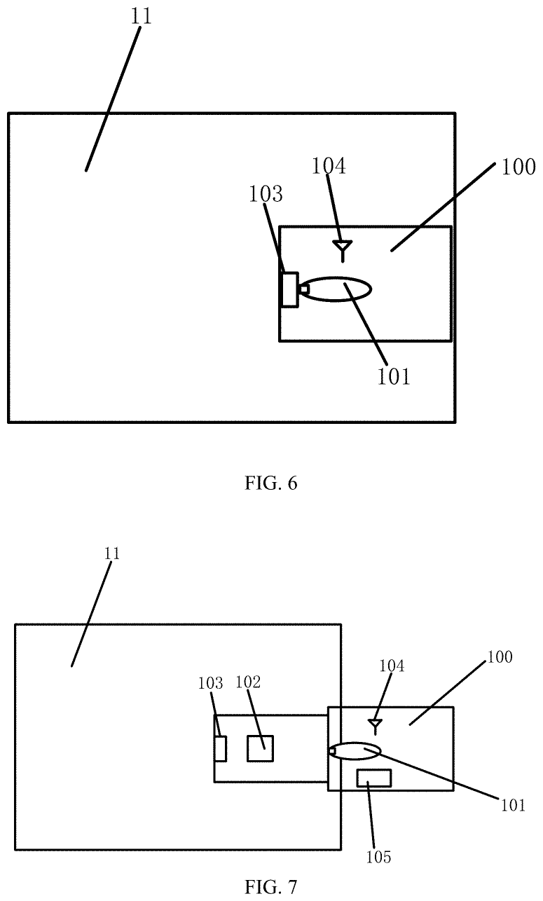

FIG. 6 is a structural diagram of an exemplary expansion device according to some embodiments of the present disclosure. FIG. 7 is a structural diagram of another exemplary expansion device according to some embodiments of the present disclosure. As shown in FIG. 6, the expansion device includes a first body 100 adapted to a first accommodation space of a processing device 11, such that the expansion device can be accommodated in the first accommodation space. The first body 100 includes a second accommodation space.

In some embodiments, the processing device 11 may be an electronic device such as a notebook computer, a cell phone, a desktop computer, a tablet computer, a game console, and a personal digital assistant. The processing device 11 is provided with the first accommodation space. The first accommodation space includes an opening that may be located at a side surface, a top surface, or a bottom surface of a body of the processing device 11. Considering that the expansion device needs to move inside the first accommodation space, the opening of the first accommodation space may be located at the side surface of the body of the processing device 11. For example, as shown in FIG. 6 and FIG. 7, the opening of the first accommodation space is located at a left-side surface or a right-side surface of the body of the processing device 11.

In some embodiments, a shape of the first accommodation space matches an overall shape of the expansion device. Considering that the expansion device needs to move back and forth inside the first accommodation space of the processing device 11, that is, the expansion device needs to be pulled out from or pushed back to the first accommodation space of the processing device 11, the overall shape of the expansion device may be a box shape. Correspondingly, the first accommodation space is a rectangular parallelepiped shape.

In some embodiments, because a first interaction component 101 needs to be placed inside the expansion device, the expansion device includes the second accommodation space. The second accommodation space is configured to accommodate the first interaction component 101. A shape of the second accommodation space matches an outer shape of the first interaction component 101. For example, when the first interaction component 101 is a wireless headset, the second accommodation space may be a recessed groove matching the shape of the wireless headset. When the wireless headset is accommodated in the recessed groove of the second accommodation space, the wireless headset is completely accommodated in the recessed groove and has no part exposed outside the recessed groove. As such, the expansion device is ensured to be pulled out from or pushed back to the first accommodation space of the processing device 11.

The first interaction component 101 can be accommodated in the second accommodation space and can be used to input and/or output data. In some embodiments, the first interaction component is the wireless headset. The wireless headset includes one or two earphones. Correspondingly, the second accommodation space is the recessed grove to accommodate the one or two earphones.

As shown in FIG. 7, the expansion device further includes a first communication component 102 configured to make a first connection with the processing device 11. The first communication component 102 communicates through physical contact.

In some embodiments, the first communication component 102 is a device that can be electrically connected with a docking device for exchanging the data or signals. For example, the first communication component 102 may be a data interface, a wiring contact pin, and a metal contact. Through the first communication component 102, the expansion device makes the first connection with the processing device 11. The first connection is a wired connection based on physical contact.

In some embodiments, the first communication component 102 is disposed at the bottom of the first body 100. As shown in FIG. 7, the first communication component 102 can only be exposed after the first body 100 moves by a certain distance.

As shown in FIG. 6 and FIG. 7, the expansion device further includes a second communication component 103 configured to make a second connection with the first interaction component 101. In some embodiments, the second communication component 103 is the metal contact. That is, one end of the first interaction component 101 is provided with a metal contact for physical contact. The metal contact is electrically connected with related parts of the first interaction component 101, such as a processor. Correspondingly, the expansion device is provided with a matching metal contact. As shown in FIG. 7, when the first body 100 is pulled out from the first accommodation space, the second communication component 103 disconnects the second connection with the expansion device. When the first body 100 is pushed back to the first accommodation space, the second communication component 103 contacts with the metal contact of the expansion device and makes the second connection with the expansion device.

As shown in FIG. 6 and FIG. 7, the expansion device further includes a third communication component 104 configured to make a third connection with the first interaction component 101. The first interaction component 101 connects with the processing device 11 through the second connection or the third connection.

In some embodiments, the third communication component 104 is a wireless communication component. For example, the third communication component 104 may be a wireless hotspot antenna or a Bluetooth antenna. In some embodiments, the third communication component 104 is the Bluetooth antenna.

As shown in FIG. 7, the expansion device further includes a first processing component 105 configured to activate the third communication component 104 in response to detecting that the second connection is disconnected and to deactivate the third communication component 104 in response to detecting that the second connection is connected. The first processing component 105 determines the connection or disconnection of the second connection by detecting whether the second communication component 103 contacts with the metal contact of the expansion device. When the second communication component 103 contacts with or separates from the metal contact of the expansion device, a voltage at the metal contact changes. A status of the second connection can be determined by detecting the voltage change at the second communication component 103.

In some embodiments, the third communication component 104 is always turned on. That is, regardless of the status of the second connection, the third communication component 104 is always turned on.

In some embodiments, the first processing component 105 may be a chip, a field programmable gate array (FPGA), or a signal processor.

In some embodiments, the first interaction component 101 includes a fourth communication component (not shown) configured to make a third connection with the third communication component 104. In some embodiments, the fourth communication component is another wireless communication component. For example, the fourth communication component may be the hotspot antenna or the Bluetooth antenna. In some embodiments, the fourth communication component is the Bluetooth antenna.

In some embodiments, the first interaction component 101 uses the fourth communication component to make another wireless connection, that is, the third connection with the third communication component 104.

The expansion device further includes a second processing component (not shown) configured to activate the fourth communication component to make the third connection with the third communication component 104 in response to detecting that the second connection is disconnected.

After the expansion device is pulled out from the first accommodation space, the first processing component detects that the second connection is disconnected, activates the third communication component 104, and launches the wireless connection function of the third communication component 104. The second processing component of the first interaction component 101 detects the status of the second connection between the second communication component 103 and the expansion device, and activates the fourth communication component in response to detecting the second connection between the second communication component 103 and the expansion device is disconnected. The first interaction component 101 uses the fourth communication component to make the third connection with the third communication component 104. Thus, the first interaction component 101 and the expansion device are connected.

In some embodiments, the second processing component may be a chip, a field programmable gate array (FPGA), or a signal processor.

In some embodiments, the second processing component deactivates the fourth communication component in response to detecting that the second connection is connected.

In some embodiments, when the first interaction component 101 is the wireless headset including a left-channel earphone and a right-channel earphone and making the wireless connection with the expansion device. In this specification, the earphone refers to either the left-channel earphone or the right-channel earphone. One earphone is a master earphone and the other earphone is a slave earphone. The master earphone makes the wireless connection with the expansion device directly. The slave earphone makes the wireless connection with the expansion device indirectly through the master earphone. That is, the slave earphone makes the wireless connection first with the master earphone and the master earphone has already made the wireless connection with the expansion device. Thus, the wireless connection between the slave earphone and the expansion device is an indirect connection. In some embodiments, the left-channel earphone is the master earphone and the right-channel earphone is the slave earphone. In some other embodiments, the right-channel earphone is the master earphone and the left-channel earphone is the slave earphone.

In some embodiments, the first interaction component 101 includes a first interaction sub-component and a second interaction sub-component. The first interaction sub-component includes a first communication sub-component in the fourth communication component configured to make the third connection with the third communication component 104 and a third communication sub-component configured to make the second connection with the second communication component 103. The second interaction sub-component includes a second communication sub-component in the fourth communication component configured to at least make a fourth connection with the first communication sub-component. In some embodiments, the fourth connection is the wireless connection between the second interaction sub-component and the first interaction sub-component.

In some embodiments, the first communication sub-component is the Bluetooth antenna located at the first interaction sub-component. The first communication sub-component in the first interaction sub-component and the second communication sub-component in the second interaction sub-component together form the fourth communication component. That is, the first interaction sub-component uses the first communication sub-component to make the third connection with the third communication component 104, thereby making the wireless connection with the expansion device.

In some embodiments, the third communication sub-component may be the interface or the metal contact. The first interaction sub-component makes the wireless connection, that is, the second connection with the expansion device through the third communication sub-component. That is, when the first interaction sub-component is separately accommodated in the second accommodation space and the expansion device is pushed back to the first accommodation space, the first interaction sub-component uses the interface or the metal contact at the third communication sub-component to contact the corresponding metal contact at the expansion device, such that the first interaction sub-component makes the second connection with the expansion device.

In some embodiments, the second processing component includes a first processing sub-component. The first processing sub-component is configured to activate the first communication sub-component to make the third connection with the third communication component 104 in response to detecting that the second connection between the third communication sub-component and the second communication component is disconnected, and to deactivate the first communication sub-component in response to detecting that the second connection between the third communication sub-component and the second communication component is connected.

In some embodiments, the second communication sub-component is the Bluetooth antenna located at the second interaction sub-component. The second communication sub-component in the first interaction sub-component and the second communication sub-component in the second interaction sub-component together form the fourth communication component. That is, the second interaction sub-component uses the second communication sub-component to make the fourth connection with the first communication sub-component of the first interaction sub-component, thereby making the wireless connection with the first interaction sub-component.

In some embodiments, the second interaction sub-component includes a fourth communication sub-component configured to make the second connection with the second communication component 103. In some embodiments, the fourth communication sub-component may be the interface or the metal contact. The second interaction sub-component makes the wireless connection, that is, the second connection with the expansion device through the fourth communication sub-component. That is, when the second interaction sub-component is separately accommodated in the second accommodation space and the expansion device is pushed back to the first accommodation space, the second interaction sub-component uses the interface or the metal contact at the fourth communication sub-component to contact the corresponding metal contact at the expansion device, such that the second interaction sub-component makes the second connection with the expansion device.

In some embodiments, the second processing component includes a second processing sub-component. The second processing sub-component is configured to activate the second communication sub-component to make the fourth connection with the first communication sub-component in response to detecting that the second connection between the fourth communication sub-component and the second communication component 103 is disconnected, and to deactivate the second communication sub-component in response to detecting that the second connection between the fourth communication sub-component and the second communication component 103 is connected.

In some embodiments, the first processing sub-component and the second processing sub-component together form the second processing component of the first interaction component 101. The first processing sub-component activates the first communication sub-component to make the third connection with the third communication component 104 in response to detecting that the second connection between the third communication sub-component and the second communication component 103 is disconnected.

In some embodiments, the second processing sub-component and the first processing sub-component together form the second processing component of the first interaction component 101. The second processing sub-component activates the second communication sub-component to make the fourth connection with the first communication sub-component of the first interaction sub-component in response to detecting that the second connection between the fourth communication sub-component and the second communication component 103 is disconnected. Thus, the second interaction sub-component connects with the expansion device through the first interaction sub-component. That is, the connection between the second interaction sub-component and the expansion device is an indirect connection.

In some embodiments, when the first interaction component 101 is the wireless headset, the first interaction sub-component may be either the left-channel earphone or the right-channel earphone. The first interaction sub-component is the master earphone.

In some embodiments, when the first interaction component 101 is the wireless headset, the second interaction sub-component may be either the left-channel earphone or the right-channel earphone. The second interaction sub-component is the slave earphone.

In some embodiments, when the fourth connection between the second communication sub-component and the first communication sub-component is disconnected, the second processing sub-component is configured to activate the second communication sub-component to make the third connection with the third communication component 104.

In some embodiments, when the second interaction sub-component as the slave earphone determines that the fourth connection between the second interaction sub-component and the first interaction sub-component is disconnected, the second interaction sub-component makes the direction connection with the third communication component 104, that is, the wireless connection between the master earphone and the expansion device.

After the second interaction sub-component as the master earphone makes the third connection with the expansion device, the first interaction sub-component activates the first communication sub-component. Instead of making the direct connection with the third communication component 104, the first communication sub-component searches for a wireless signal transmitted by the second communication sub-component of the second interaction sub-component and makes the fourth connection with the second communication sub-component. That is, after the first interaction sub-component determines that the third connection between the second interaction sub-component and the expansion device is connected, the first interaction sub-component as the slave earphone makes the fourth connection with the second interaction sub-component.

In some embodiments, the first communication component 102, the second communication component 103, the third communication sub-component, and the fourth communication sub-component are the communication component by physical contact. The third communication component 104 and the fourth communication component are the wireless communication component.

In the embodiments of the present disclosure, the expansion device is accommodated in the first accommodation space provided by the processing device. The expansion device includes the second accommodation space for accommodating the first interaction component. The first connection and the second connection are formed between the processing device and the expansion device. The expansion device makes the third connection with the first interaction component. When the expansion device detects that the second connection between the expansion device and the processing device is disconnected, that is, the expansion device moves relative to the first accommodation space to disconnect the second connection between the expansion device and the processing device, the first interaction component is automatically activated to make the third connection with the expansion device. Then, after the processing device determines that the third connection between the expansion device and the first interaction component is connected, the processing device closes the current data channel with the second interaction component in the processing device, redirects the data channel to the first connection between the processing device and the expansion device, and connects with the first interaction component through the third connection. After it is detected that the second connection between the expansion device and the processing device is connected, that is, the expansion device is again accommodated in the first accommodation space, the expansion device disconnects the third connection with the first interaction component.

In the embodiments of the present disclosure, by providing the expansion device inside the processing device and accommodating the first interaction component inside the expansion device, the first interaction component can be stored inside the processing device. When needed, the expansion device is pulled out from the processing device, and the first interaction component is pulled out from the expansion device. Then, the first interaction component automatically connects with the expansion device and the processing device, thereby making it convenient for the user to operate the first interaction component and preventing the first interaction component from getting lost.

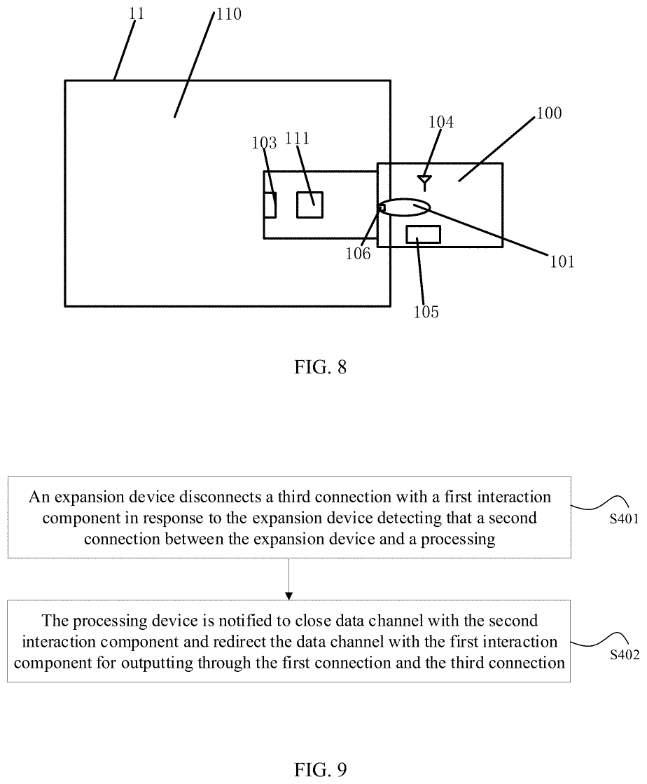

FIG. 8 is a structural diagram of an exemplary processing device according to some embodiments of the present disclosure. As shown in FIG. 8, the processing device 11 includes a second body 110 including a first accommodation space and a fifth communication component 111 configured to make a first connection with an expansion device. The expansion device includes a first body 100 adapted to the first accommodation space, a first communication component configured to make the first connection with the fifth communication component 111, a second communication component 103 configured to make a second connection with a first interaction component 101, and a third communication component 104 configured to make a third connection with the interaction component 101.

The first body 100 allows the expansion device to be accommodated in the first accommodation space. The first body 100 includes a second accommodation space. The interaction component 101 can be accommodated in the second accommodation space. The interaction component 101 includes a sixth communication component 106 configured to make the second connection with the second communication component 103. The first interaction component 101 can be connected through the second connection or the third connection.

In some embodiments, the fifth communication component 111 is a communication component by physical contact and makes the second connection with the second communication component 103 at the expansion device. The second communication component 103 may be arranged on a sliding rail or a fixed connection member at the expansion device. The fifth communication component 111 is connected with the second communication component 103 through a corresponding connection interface, and this connection is the first connection.

In some embodiments, the first interaction component 101 includes the sixth communication component 106. When the first interaction component 101 is accommodated in the second accommodation space and the expansion device is accommodated in the first accommodation space, the sixth communication component 106 connects with the second communication component 103.

With reference to the embodiments shown in FIG. 6 and FIG. 7, a third communication component and a fourth communication component together form the sixth communication component 106.

In some embodiments, the first interaction component 101 further includes the fourth communication component (not shown) matching the third communication component 104. The fourth communication component is a wireless communication component, such as a wireless hotspot antenna or a Bluetooth antenna. In some embodiments, the fourth communication component is the Bluetooth antenna.

In some embodiments, the processing device 11 further includes a seventh communication component matching the third communication component 104. The seventh communication component and the fourth communication component may be connected. The seventh communication component is the wireless communication component, such as the wireless hotspot antenna or the Bluetooth antenna. In some embodiments, the seventh communication component is the Bluetooth antenna.

In some embodiments, the processing device 11 is provided with a Bluetooth communication circuit, that is, the seventh communication component, such that the first interaction component 101 uses the seventh communication component to make the third connection directly with the processing device 11.

In some embodiments, the first interaction component 101 makes the third connection with the expansion device.

In some embodiments, the processing device 11 further includes a second interaction component (not shown) configured to input and/or output data, a third processing component (not shown) configured to detect a status of the second connection. When the third connection is connected, the third processing component closes data channel with the second interaction component, and redirects the data channel with the first connection to connect with the second interaction component.

In some embodiments, the processing device 11 is provided with the third processing component. The third processing component detects the status of the second connection through the first connection. When the third processing component detects that the second connection is disconnected and the third connection is connected, the third processing component closes the data channel with the second interaction component, redirects the data channel with the first connection to connect with the second interaction component.

In some embodiments, the second interaction component may be a speaker or a video output terminal of the processing device 11. After the video output terminal of the processing device 11 is closed or shut down, no audio video data can be outputted from the processing device 11. Instead, the audio video data may be outputted through the first interaction component 101. That is, when it is detected that the third connection between the first interaction component 101 and the expansion device is connected and the audio video data are outputted through the first interaction component 101, the current audio video output from the processing device is closed or shut down, and the audio video data are outputted by the first interaction component 101 through the first connection and the third connection.

In some embodiments, it Is not necessary to close the data channel with the second interaction component of the processing device 11. The data channel with the second interaction component is duplicated. The duplicated data are outputted to the first interaction component 101 through the first connection and the third connection. Both the first interaction component 101 and the second interaction component output the corresponding data.

In some embodiments, the third processing component may be a chip, a field programmable gate array (FPGA), or a signal processor.

In some embodiments, the processing device 11 may be an electronic device such as a notebook computer, a cell phone, a desktop computer, a tablet computer, a game console, and a personal digital assistant.

The structures and functions of the processing device 11 may be referred to the description of the embodiments shown in FIG. 6 and FIG. 7.

In the embodiments of the present disclosure, the expansion device is accommodated in the first accommodation space provided by the processing device. The expansion device includes the second accommodation space for accommodating the first interaction component. The first connection and the second connection are formed between the processing device and the expansion device. The expansion device makes the third connection with the first interaction component. When the expansion device detects that the second connection between the expansion device and the processing device is disconnected, that is, the expansion device moves relative to the first accommodation space to disconnect the second connection between the expansion device and the processing device, the first interaction component is automatically activated to make the third connection with the expansion device. Then, after the processing device determines that the third connection between the expansion device and the first interaction component is connected, the processing device closes the current data channel with the second interaction component in the processing device, redirects the data channel to the first connection between the processing device and the expansion device, and connects with the first interaction component through the third connection. After it is detected that the second connection between the expansion device and the processing device is connected, that is, the expansion device is again accommodated in the first accommodation space, the expansion device disconnects the third connection with the first interaction component.

In the embodiments of the present disclosure, by providing the expansion device inside the processing device and accommodating the first interaction component inside the expansion device, the first interaction component can be stored inside the processing device. When needed, the expansion device is pulled out from the processing device, and the first interaction component is pulled out from the expansion device. Then, the first interaction component automatically connects with the expansion device and the processing device, thereby making it convenient for the user to operate the first interaction component and preventing the first interaction component from getting lost.

FIG. 9 is a flowchart illustrating an exemplary data transmission method according to some embodiments of the present disclosure. As shown in FIG. 9, the data transmission method includes the following processes.

At S401, an expansion device disconnects a third connection with a first interaction component in response to the expansion device detecting that a second connection between the expansion device and a processing.

Specifically, the processing device includes a second body including a first accommodation space, and a fifth communication component configured to make a first connection with the expansion device. The expansion device includes a first body adapted to the first accommodation space, such that the expansion device can be accommodated in the first accommodation space. The first body includes a second accommodation space. The expansion device further includes a first communication component configured to make the first connection with the fifth communication component, a second communication component configured to make a second connection with the first interaction component, a third communication component configured to make a third connection with the first interaction component, and the first interaction component being accommodated in the second accommodation space. The first interaction component includes a sixth communication component configured to make the second connection with the second communication component.

The connection methods and operations of the expansion device, the processing device, the first interaction component, and a second interaction component may be referred to the description of the embodiments shown in FIG. 6, FIG. 7, and FIG. 8.

In some embodiments, when the expansion device determines that the second connection between the first interaction component and the expansion device is disconnected, the expansion device activates the third communication component in the expansion device to make the third connection. At the same time, the expansion device notifies the first interaction component to activate the sixth communication component to make the third connection, such that the first interaction component makes the third connection with the expansion device. The third connection is a wireless connection and the second connection between the first interaction component and the expansion device is a wired connection.

It should be noted that the first interaction component is also able to detect a status of the second connection. When the first interaction component detects that the second connection between the first interaction component and the expansion device is disconnected, the first interaction component activates the sixth communication component to make the third connection, such that the third connection between the first interaction component and the expansion device is connected.

At S402, the processing device is notified to close data channel with the second interaction component and redirect the data channel with the first interaction component for outputting through the first connection and the third connection.

After the expansion device determines that the third connection between the first interaction component and the expansion device is connected, the expansion device notifies the processing device to close the data channel with the second interaction component and redirect the data channel with the first interaction component for outputting through the first connection and the third connection.

In the embodiments of the present disclosure, the expansion device is accommodated in the first accommodation space provided by the processing device. The expansion device includes the second accommodation space for accommodating the first interaction component. The first connection and the second connection are formed between the processing device and the expansion device. The expansion device makes the third connection with the first interaction component. When the expansion device detects that the second connection between the expansion device and the processing device is disconnected, that is, the expansion device moves relative to the first accommodation space to disconnect the second connection between the expansion device and the processing device, the first interaction component is automatically activated to make the third connection with the expansion device. Then, after the processing device determines that the third connection between the expansion device and the first interaction component is connected, the processing device closes the current data channel with the second interaction component in the processing device, redirects the data channel to the first connection between the processing device and the expansion device, and connects with the first interaction component through the third connection. After it is detected that the second connection between the expansion device and the processing device is connected, that is, the expansion device is again accommodated in the first accommodation space, the expansion device disconnects the third connection with the first interaction component.

In the embodiments of the present disclosure, by providing the expansion device inside the processing device and accommodating the first interaction component inside the expansion device, the first interaction component can be stored inside the processing device. When needed, the expansion device is pulled out from the processing device, and the first interaction component is pulled out from the expansion device. Then, the first interaction component automatically connects with the expansion device and the processing device, thereby making it convenient for the user to operate the first interaction component and preventing the first interaction component from getting lost.

The technical solutions of the embodiments of the present disclosure will be further described below with reference to practical application examples.

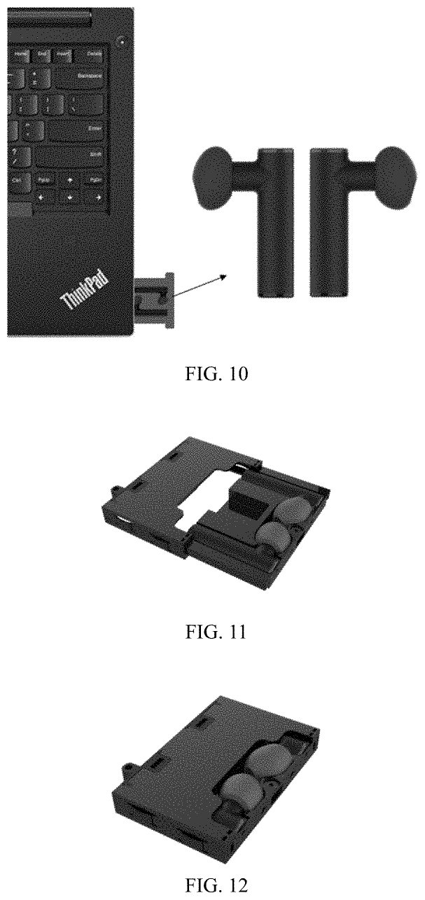

FIG. 10 is a schematic diagram of an application example of a processing device and a first interaction component according to some embodiments of the present disclosure. As shown in FIG. 10, the processing device may be a laptop computer, a game console, a tablet computer, and a PAD. For illustration purpose, the laptop computer is described in the embodiments of the present disclosure. A first accommodation space is provided at a side of the main body of the laptop computer for accommodating an expansion device consistent with the present disclosure. A shape of the first accommodation space matches an overall shape of the expansion device.

For illustration purpose, a first interaction component is a wireless headset including two earphones. One of the two earphones is a master earphone and the other earphone is a slave earphone. The master earphone connects directly with the expansion device through a Bluetooth method. The slave earphone connects with the master earphone through the Bluetooth method. The slave earphone connects with the expansion device through the master earphone.

FIG. 11 is a schematic diagram of an application example of an expansion device and a first interaction component according to some embodiments of the present disclosure. FIG. 12 is a schematic diagram of another application example of an expansion device and a first interaction component according to some embodiments of the present disclosure. As shown in FIG. 11 and FIG. 12, the expansion device is a tray. The tray is provided with a Bluetooth antenna for Bluetooth connection. The tray includes a fixed portion for attaching to a main body of a laptop computer and a sliding portion capable of sliding along the fixed portion. The sliding portion slides along the fixed portion to allow the tray to be slid into a first accommodation space or out of the first accommodation space. Two recessed grooves are provided at the sliding portion of the tray for accommodating two earphones. When the two earphones are placed in the two recessed grooves at the sliding portion of the tray, the earphones are fully accommodated by the recessed grooves. As such, when the tray is accommodated in the first accommodation space and the sliding portion slides along the fixed portion, the sliding portion of the tray slides in the first accommodation space without any obstruction. In some embodiments, the recessed grooves on the sliding portion of the tray are a second accommodation space provided by the tray.

After the tray receives an ejection command, the tray is ejected from the first accommodation space of the laptop computer. In some embodiments, after the ejection of the tray, a wireless headset is automatically activated, and a Bluetooth function thereof is launched. Because the tray also supports the Bluetooth function, the tray launches the Bluetooth function after the tray is ejected from the first accommodation space of the laptop computer. In some other embodiments, the tray leaves the Bluetooth function on regardless of whether the tray is ejected from the first accommodation space of the laptop computer.

After the ejection of the tray, a controller provided by the tray is activated to detect a number of earphones at the tray. When the tray detects no earphone, the tray may turn off the Bluetooth function. When the tray detects an earphone, the tray turns on the Bluetooth function.

In some embodiments, the controller of the tray detects a status of a connection with the at least one earphone. When no connection is detected, the tray restarts the Bluetooth function. When the connection is detected, the controller notifies an audio card of a processing device (e.g., the laptop computer), stops the audio card from outputting audio data to a speaker of the processing device, and switches the audio data from being outputted to the speaker of the processing device to being outputted to the earphone connected through a Bluetooth connection between the tray and the earphone. As such, a user may listen to the audio data currently played by the processing device through the earphone. When the first interaction component supports video input and/or video output, the controller may output audio video data from the processing device to the first interaction component through the tray. For example, when the first interaction component is a virtual reality (VR) helmet, the audio video data are outputted from the processing device to the VR helmet for viewing and listening by the user.

In some embodiments, after the ejection of the tray, the controller of the tray is activated to detect a number of earphones at the tray and whether any earphone is pulled out by the user. When the controller detects no earphone at the tray or no earphone being pulled out by the user (i.e., the earphone always contacts with the tray), the controller turns off the Bluetooth function of the tray. When it is detected that only one of two earphones at the tray is pulled out, the earphone still at the tray may be turned off immediately or maybe be turned off after the tray is pushed back to the first accommodation space of the laptop computer. The Bluetooth function of the tray is turned on. As a master earphone, the pulled-out earphone makes the Bluetooth connection with the tray. The controller determines a status of the Bluetooth connection with the pulled-out earphone. When the Bluetooth connect is connected, the controller notifies the audio card of the processing device, stops the audio card from outputting the audio data to the speaker of the processing device, and switches the audio data from being outputted to the speaker of the processing device to being outputted to the earphone connected through the Bluetooth connection between the tray and the earphone. After the other earphone at tray is pulled out, the other pulled-out earphone becomes a slave earphone to make the Bluetooth connection with the currently connected master earphone and to receive the audio video data sent by the master earphone. When the controller of the tray detects that the two earphones at the tray are both pulled out, the controller turns on the Bluetooth function of the tray. The two earphones also turn on the Bluetooth function. One of the two pulled-out earphones is pre-configured to be the master earphone. For example, a left-channel earphone is pre-configured to be the master earphone, or a right-channel earphone is pre-configured to be the master earphone. As such, the master earphone searches for the Bluetooth connection of the tray and makes a third connection (i.e., the Bluetooth connection) with the tray. The slave earphone makes the Bluetooth connection with the master earphone, and receives the audio video data sent by the processing device through the master earphone.

In some embodiments, when being pulled out from the tray is a condition for turning on the earphone, being placed back to the tray is a condition for turning off the earphone. In some other embodiments, the condition for turning off the earphone includes placing the earphone back to the tray and pushing the tray back to the first accommodation space of the laptop computer.

In some embodiments, the two earphones are not pre-configured to be the master earphone and the slave earphone respectively. After the ejection of the tray, the controller of the tray is activated to detect the number of earphones at the tray and whether any of the two earphones is pulled out by the user. When the controller detects no earphone at the tray or no earphone being pulled out by the user (i.e., the earphone always contacts with the tray), the controller turns off the Bluetooth function of the tray. When it is detected that the two earphones at the tray are both pulled out, the two earphones are activated to turn on the Bluetooth function. Initially, each earphone searches for the other earphone to determine whether the other earphone has already made the Bluetooth connection with the tray. That is, each earphone needs to determine whether one of the two earphones has made the third connection with the tray as the master earphone. When no master earphone is detected, each earphone attempts to make the third connection with the tray. The earphone that makes the third connection with the tray first automatically becomes the master earphone, and the other earphone becomes the slave earphone. The slave earphone makes a fourth connection with the master earphone to indirectly connect with the tray, and receives data (e.g., audio data) from the processing device sent by the master earphone. When one of the two earphones that are not pre-configured to be the master earphone is pulled out, the pulled-out earphone is activated to turn on the Bluetooth function. When no master earphone is detected, the pulled-out earphone makes the third connection with the tray and becomes the master earphone. After the master earphone makes the third connection with the tray, the other earphone is pulled out from the tray. After the master earphone is detected, the other pulled-out earphone makes the fourth connection with the master earphone.

In some embodiments, the condition to activate the earphone includes the ejection of the tray from the laptop computer or the pulling-out of the earphone from the tray, that is, pulling out the earphone from the ejected tray.

In the embodiments of the present disclosure, the expansion device is accommodated in the first accommodation space provided by the processing device. The expansion device includes the second accommodation space for accommodating the first interaction component. The first connection and the second connection are formed between the processing device and the expansion device. The expansion device makes the third connection with the first interaction component. When the expansion device detects that the second connection between the expansion device and the processing device is disconnected, that is, the expansion device moves relative to the first accommodation space to disconnect the second connection between the expansion device and the processing device, the first interaction component is automatically activated to make the third connection with the expansion device. Then, after the processing device determines that the third connection between the expansion device and the first interaction component is connected, the processing device closes the current data channel with the second interaction component in the processing device, redirects the data channel to the first connection between the processing device and the expansion device, and connects with the first interaction component through the third connection. After it is detected that the second connection between the expansion device and the processing device is connected, that is, the expansion device is again accommodated in the first accommodation space, the expansion device disconnects the third connection with the first interaction component.

In the embodiments of the present disclosure, by providing the expansion device inside the processing device and accommodating the first interaction component inside the expansion device, the first interaction component can be stored inside the processing device. When needed, the expansion device is pulled out from the processing device, and the first interaction component is pulled out from the expansion device. Then, the first interaction component automatically connects with the expansion device and the processing device, thereby making it convenient for the user to operate the first interaction component and preventing the first interaction component from getting lost.

In the embodiments of the present disclosure, the control method and the control apparatus may be implemented in other ways. The embodiments described above are merely illustrative. For example, the division of the circuits is only a logical function division, and there may be other ways of division in practical implementations. Multiple circuits or components may be combined or integrated to form another system. Some features may be omitted or may not be executed. In addition, coupling, direct coupling, communication connection through certain interface, or indirect coupling or communication connection between devices or circuits may be electrical, mechanical, or in another form.

The circuits described above as separate components may or may not be physically separate, and the components displayed as separate circuits may or may not be physical circuits. That is, the circuits may be located at one place or distributed at multiple network circuits. Some or all of the circuits may be selected as needed to achieve the objectives of the technical solutions of the embodiments of the present disclosure.

In addition, functional modules in the embodiments of the present disclosure may be integrated into one processing module, may function as individual functional modules, or may be integrated by combining two or more functional modules. The functional modules may be implemented in the form of hardware or combination of hardware and software.

Those skilled in the art should understand that some or all of the processes in the method embodiments may be implemented by program instructions controlling relevant hardware. The program instructions may be stored in a computer-readable storage medium. When being executed, the program instructions perform the processes in the method embodiments. The computer-readable storage medium may include, but is not limited to, a removable storage device, a read-only memory (ROM), a random-access memory (RAM), a magnetic disk, an optical disk, or another medium suitable for storing the program instructions.

In the embodiments of the present disclosure, when the integrated circuits are implemented in the form of software functional modules and sold or used as an independent product, the software product may be stored in the computer-readable storage medium. Based on this understanding, in essence or a part that contributes the innovation, the technical solutions of the embodiments of the present disclosure may be embodied in the form of a software product. The computer software product stored in the storage medium includes a plurality of program instructions to make a computer device (e.g., a personal computer, a server, or a network device) execute all or part of the methods described in various embodiments of the present disclosure. The storage medium includes, but is not limited to, a removable storage device, a read-only memory (ROM), a random-access memory (RAM), a magnetic disk, an optical disk, or another medium suitable for storing the program instructions.

In the specification, specific examples are used to explain the principles and implementations of the present disclosure. The description of the embodiments is intended to assist comprehension of the methods and core ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A control method comprising:
making, by a first interaction component, a wireless connection according to a connection rule in response to the first interaction component switching from a first state to a second state; and
making, by a second interaction component, the wireless connection according to the connection rule in response to the second interaction component switching from the first state to the second state.

2. The method according to claim 1, wherein:
the first state refers to a state that an interaction component is in contact with a target contact surface and the second state refers to a state that the interaction component is separated from the target contact surface; or
the first state refers to that an interaction component is communicatively connected with a target device, and the second state refers to that the interaction component is communicatively disconnected from the target device.

3. The method according to claim 1, wherein:
the wireless connection is a Bluetooth connection or a Wi-Fi connection.

4. The method according to claim 1, wherein:
the first interaction component is a left-channel earphone of a wireless headset and the second interaction component is a right-channel earphone of the wireless headset; or
the first interaction component is the right-channel earphone of the wireless headset and the second interaction component is the left-channel earphone of the wireless headset.

5. The method according to claim 1, wherein the connection rule includes:
an interaction component attempts to connect with another interaction component and attempts to connect with a target device in response to the attempt to connect with another interaction component failing; or
an interaction component attempts to connect with another interaction component, attempts to connect with the target device in response to the attempt to connect with another interaction component failing, attempts to connect with a previously connected device in response to the attempt to connect with the target device failing, and enters a pairing connection state in response to the attempt to connect with the previously connected device failing.

6. The method according to claim 1, wherein:
when the second interaction component remains in the first state and the first interaction component switches from the first state to the second state, the first interaction component makes a first connection with a target device according to the connection rule; and
when the first interaction component remains in the first state and the second interaction component switches from the first state to the second state, the second interaction component makes the first connection with the target device according to the connection rule.

7. The method according to claim 6, wherein:
after the first interaction component and the second interaction component both switch from the first state to the second state, the first interaction component and the second interaction component are connected with the target device in different manners.

8. The method according to claim 7, wherein:
when the first interaction component makes the first connection directly with the target device, the second interaction component makes the first connection with the target device indirectly through the first interaction component; and
when the second interaction component makes the first connection directly with the target device, the first interaction component makes the first connection with the target device indirectly through the second interaction component.

9. The method according to claim 1, further comprising:
activating a wireless circuit of an interaction component in response to an interaction component switching from a third state to a fourth state,
wherein:
the first interaction component includes a first wireless circuit and the second interaction component includes a second wireless circuit;
the third state refers to that a second connection between an expansion device and a processing device is connected and the fourth state refers to that the second connection between the expansion device and the processing device is disconnected;
the interaction component is disposed inside the expansion device and is in the first state; and
the second state is different from the first state.

10. An expansion device comprising:
a first body adapted to a first accommodation space of a processing device for accommodating the expansion device, and including a second accommodation space;
a first interaction component configured to be accommodated in the second accommodation space and input and/or output data;
a first communication component configured to make a first connection with the processing device;
a second communication component configured to make a second connection with the first interaction component; and
a third communication component configured to make a third connection with the first interaction component, wherein the first interaction component connects with the processing device through the second connection or the third connection.

11. The expansion device according to claim 10, wherein:
the processing device a laptop computer, a game console, or a tablet computer.

12. The expansion device according to claim 10, wherein:
the expansion device is a tray holding the first interaction component; and
the first interaction component is a wireless headset.

13. The expansion device according to claim 10, further comprising:
a first processing component configured to activate the third communication component in response to detecting that the second connection is disconnected and to deactivate the third communication component in response to that the second connection is connected.

14. The expansion device according to claim 13, wherein the first interaction component comprises:
a fourth communication component configured to make the third connection with the third communication component; and
a second processing component configured to activate the fourth communication component to make the third connection with the third communication component in response to detecting that the second connection is disconnected.

15. The expansion device according to claim 14, wherein:
the second processing component is further configured to deactivate the fourth communication component in response to detecting that the second connection is connected.

16. The expansion device according to claim 14, wherein the first interaction component includes:
a first interaction sub-component including:
a first communication sub-component of the fourth communication component configured to make the third connection with the third communication component;
a third communication sub-component configured to make the second connection with the second communication component; and
a first processing sub-component of the second processing component configured to activate the first communication sub-component to make the third connection with the third communication component in response to detecting that the second connection between the third communication sub-component and the second communication component is disconnected and to deactivate the first communication sub-component in response to detecting that the second connection between the third communication sub-component and the second communication component is connected; and
a second interaction sub-component including:
a second communication sub-component of the fourth communication component configured to at least make a fourth connection with the first communication sub-component;
a fourth communication sub-component configured to make the second connection with the second communication component; and
a second processing sub-component of the second processing component configured to activate the second communication sub-component to make the fourth connection with the first communication sub-component in response to detecting that the second connection between the fourth communication sub-component and the second communication component is disconnected and to deactivate the second communication sub-component in response to detecting that the second connection between the fourth communication sub-component and the second communication component is connected.

17. The expansion device according to claim 16, wherein:
when the fourth connection between the second communication sub-component and the first communication sub-component is disconnected, the second processing sub-component is configured to activate the second communication sub-component to make the third connection with the third communication component.

18. A processing device comprising:
a second body including a first accommodation space;
a fifth communication component configured to make a first connection with an expansion device; and
the expansion device including:
a first body adapted to the first accommodation space and including a second accommodation space, such that the expansion device is accommodated in the first accommodation space;
a first communication component configured to make the first connection with the fifth communication component;
a second communication component configured to make a second connection with a first interaction component;
a third communication component configured to make a third connection with the first interaction component; and
the first interaction component capable of being accommodated in the second accommodation space and including a sixth communication component configured to make the second connection with the second communication component, wherein the first interaction component is connected through the second connection or the third connection.

19. The processing device according to claim 18, wherein:
the first interaction component further includes a fourth communication component matching the third communication component; and
the processing device further includes a seventh communication component matching the third communication component, wherein the seventh communication component is connected with the fourth communication component.

20. The processing device according to claim 19, further comprising:
a second interaction component configured to input and/or output data; and
a third processing component configured to, in response to detecting that the second connection is disconnected and the third connection is connected, close data channel with the second interaction component, and switch the closed data channel to the first connection to connect with the first interaction component.
